(19) United States
(12) Patent Application Publication
(10) Pub. No.: US 2026/0084739 A1
(43) Pub. Date: Mar. 26, 2026

(54) HEATED STEERING WHEEL ABLE TO BE MOUNTED TO DIFFERENT TYPE OF VEHICLE

(71) Applicant: TONG YAH ELECTRONIC TECHNOLOGY CO., LTD., TAINAN CITY (TW)

(72) Inventor: TSUNG-MIN WU, TAINAN CITY (TW)

(21) Appl. No.: 18/897,233

(22) Filed: Sep. 26, 2024

(51) Int. Cl. B62D 1/06

(52) U.S. Cl. CPC B62D 1/065

(57) ABSTRACT

A heated steering wheel able to be mounted to different types of vehicles and including a wheel base module under a steering wheel is provided. The wheel base module includes an upper cap, a rotary disc cover, a rotary disc, and a base. The rotary disc is mounted into the base and having horizontally-arranged inner and outer circular tracks. The rotary disc cover covering the rotary disc is connected to the base and provided with guide assemblies contacted with inner and outer conductive rings for conducting electricity. The upper cap is covering the rotary disc cover and provided with a bushing by which the wheel base module is connected to a clamp ring set or a C-shaped fastener for driving a control shaft for steering of the vehicles. Thereby tangling problems caused by flexible flat cables can be solved, volume is reduced, and more stable electric conduction is provided.

### BACKGROUND OF THE INVENTION

### Field of the Invention

The present invention relates to a heated steering wheel able to be mounted to different types of vehicles conveniently, which not only avoids tangling problems caused by flexible flat cables, but also reduces volume of power transmission modules and provides good conductive technology.

### Description of Related Art

In cold, low-temperature, and polar regions of Earth, cold hands affect a driver's ability to operate vehicles effectively while moving from one place to another place by the vehicles such as motorcycles, snowcats, golf carts, all terrain vehicles (ATV), utility terrain vehicles (UTV), and agricultural vehicles. The low temperature also easily leads to material embrittlement or hardening of grips due to physical and chemical property change (degradation) and this further impacts operating control of the vehicles. In order to solve the above problems, people in the filed add heating films in the vehicle grip or steering wheel. Thus heat generated by the heating film not only keeps the driver's hands warm but also heats the vehicle grip or the steering wheel for preventing the vehicle grip or the steering wheel from degradation or damage.

As to a conventional conductive heating structure of steering wheels in vehicles, it mainly includes a base disposed under a steering wheel and provided with a certain space for mounting a wound flat cables therein. The wound flat cables have a certain length for allowing steering of the steering wheel while a top of one end of the flat cables is connected to the steering wheel and a bottom of the other end of the flat cables is connected to power supply equipment in the vehicle. A vertical axial design of conductive contacts is achieved by the wound flexible flat cables. For assembly of the base with one end of a shaft for control of steering, an axial hole is integrally formed (or integrally injection molded) on the base for connection with the shaft. The above conventional structure has the following shortcomings.

1. The axial hole of the base has fixed shape and size so that the base can be used only in a specific vehicle. For applications to different types of vehicles, a variety of the bases with different specifications for different types of vehicles are produced. Thereby cost for production and inventory items is increased.

2. A certain height is required due to the wound flexible flat cables and the vertical axial design of the conductive contacts. The wound flexible flat cables and space required for release both occupy a lot space. Thereby the base should have a certain volume, unable to be compacted. Besides length limit, the wound flexible flat cables may cause tangling problems after the steering wheel being rotated repeatedly. Thus there is room for improvement and there is a need to provide a novel structure of the steering wheel for control of vehicles.

### SUMMARY OF THE INVENTION

Therefore, it is a primary object of the present invention to provide a heated steering wheel able to be mounted to different types of vehicles conveniently, which not only reduces volume of power transmission modules but also provides good electric conduction.

In order to achieve the above object, a heated steering wheel able to be mounted to different types of vehicles conveniently according to the present invention mainly includes a wheel base module disposed under a steering wheel. The wheel base module is mainly composed of an upper cap, a rotary disc cover, a rotary disc, and a base. The rotary disc is mounted into the base correspondingly and provided with inner and outer circular tracks disposed horizontally. The rotary disc cover is covering the rotary disc, connected to the base, and provided with guide assemblies in contact with inner and outer conductive rings correspondingly for conducting electric power. The upper cap is covering the rotary disc cover and provided with a bushing corresponding to different types of the vehicles. By the bushing, the wheel base module is connected to a clamp ring set or a C-shaped fastener correspondingly for driving a control shaft for steering of the vehicles. Thereby the heated steering wheel can be mounted to different types of vehicles. Not only length limits or tangling problems caused by conventional flexible flat cables can be improved or solved, volume is also effectively reduced and good electric conduction is provided.

### BRIEF DESCRIPTION OF THE DRAWINGS

FIG. 1 is an exploded view of an embodiment according to the present invention;

FIG. 2 is an exploded view of a wheel base module of an embodiment according to the present invention;

FIG. 3 is an exploded view of a rotary disc cover, guide assemblies, a rotary disc, and conductive rings of an embodiment according to the present invention;

FIG. 4 is an exploded view of a rotary disc cover and a rotary disc of an embodiment according to the present invention;

FIG. 5 is a sectional view of a rotary disc cover assembled with a rotary disc of an embodiment according to the present invention;

FIG. 6 is a top view of an upper cap and a bushing of an embodiment according to the present invention;

FIG. 7 is a sectional view of an upper cap assembled with a bushing of an embodiment according to the present invention;

FIG. 8 is a schematic drawing showing a bushing and a style of an axial hole of an embodiment according to the present invention;

FIG. 9 is another schematic drawing showing a bushing and a style of an axial hole of an embodiment according to the present invention;

FIG. 10 is a further schematic drawing showing a bushing and a style of an axial hole of an embodiment according to the present invention;

FIG. 11 is a further schematic drawing showing a bushing and a style of an axial hole of an embodiment according to the present invention;

FIG. 12 is an exploded view of a part of components of a wheel base module of an embodiment according to the present invention;

FIG. 13 is a schematic drawing showing a wire seat mounted in a C-shaped fastener of a control shaft of an embodiment according to the present invention.

### DETAILED DESCRIPTION OF THE PREFERRED EMBODIMENT

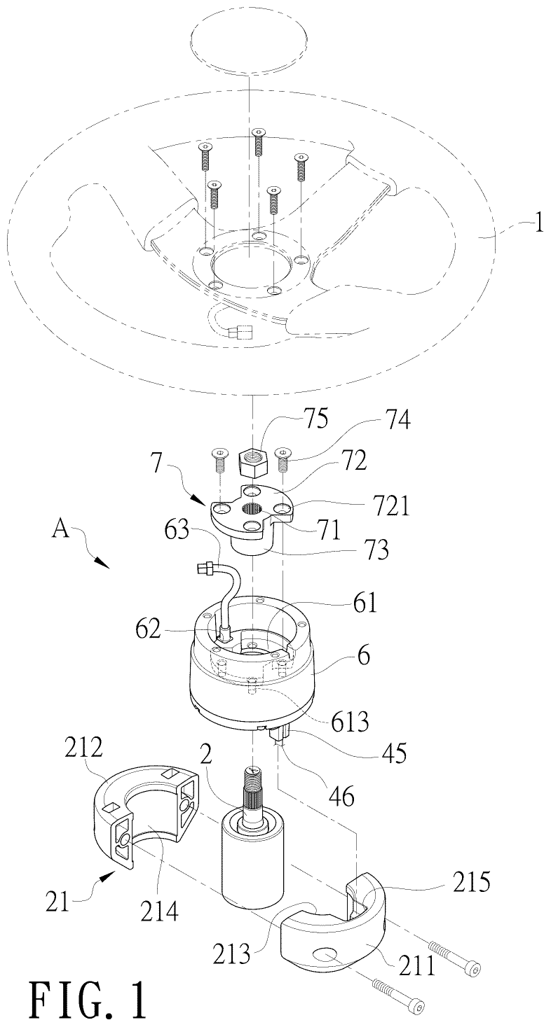

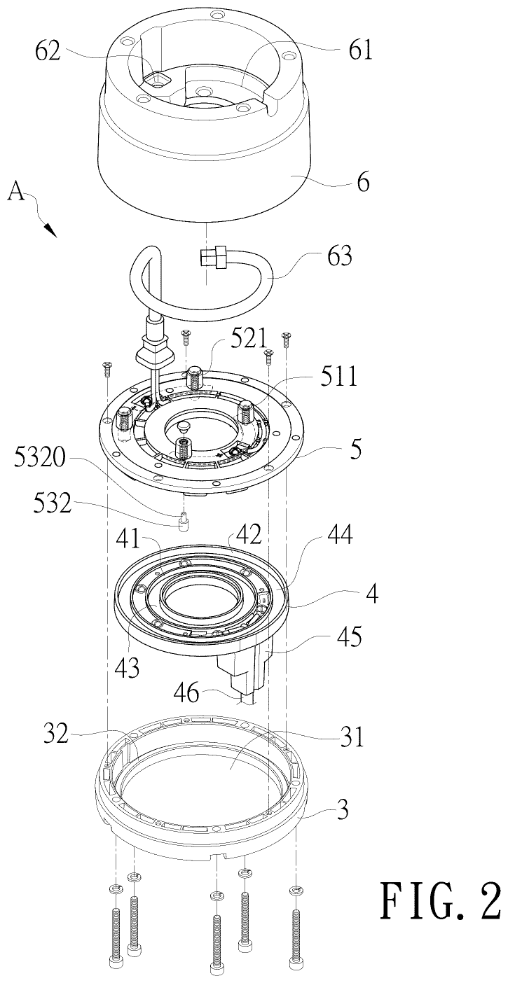

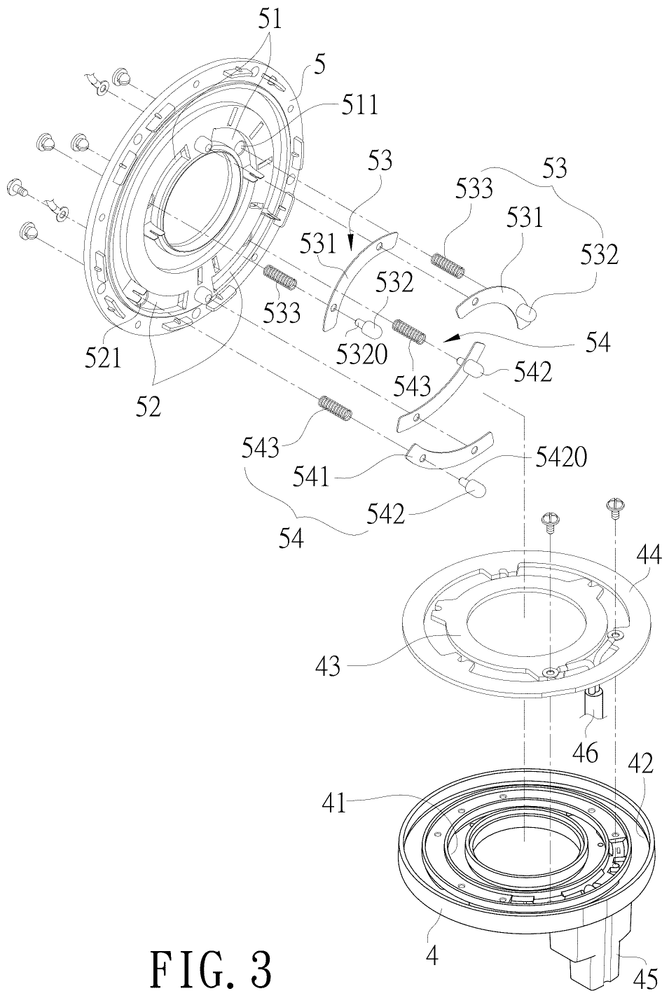

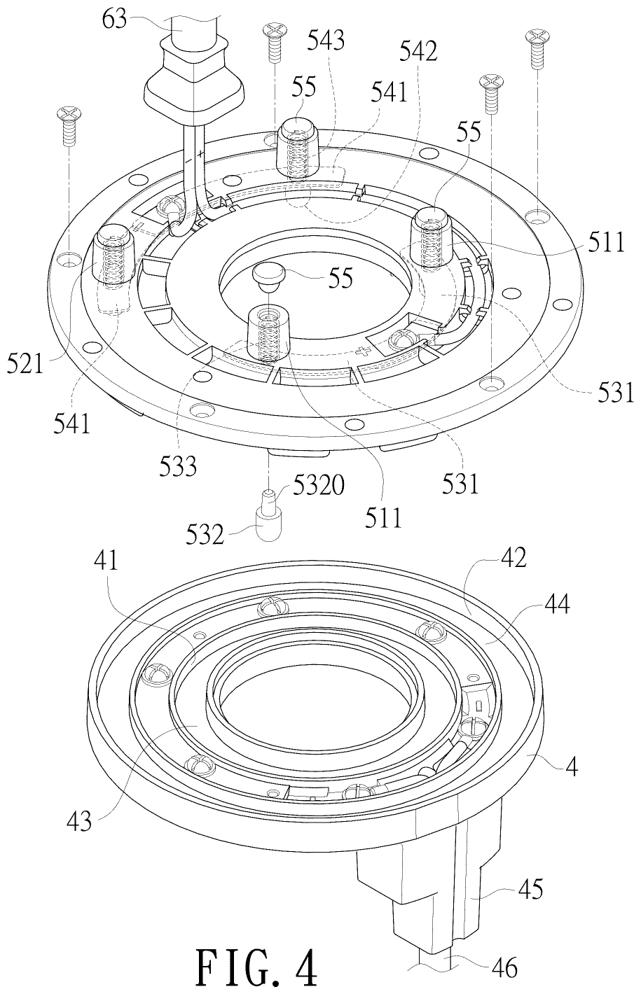

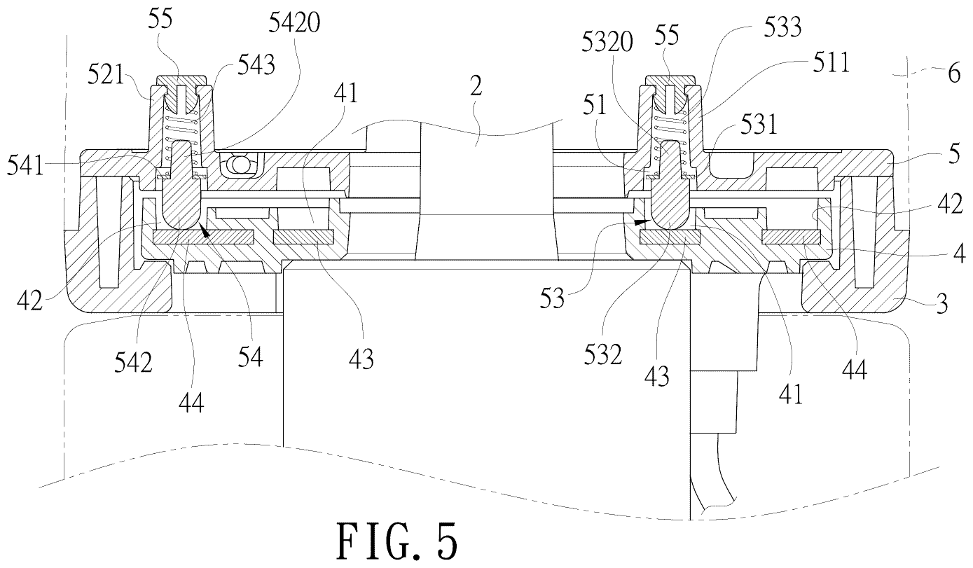

Refer to FIG. 1-5, a heated steering wheel able to be mounted to different vehicles according to the present invention mainly includes a wheel base module A disposed under a steering wheel 1 and connected to a control shaft 2 used for steering of the vehicles. The wheel base module A consists of a base 3, a rotary disc 4, a rotary disc cover 5, and an upper cap 6.

The base 3 is provided with a hole 31 disposed on a center of the base 3 and a loading ring portion 32 mounted to an inner circumference of the hole 31.

The rotary disc 4 is mounted into the base 3 correspondingly and loaded on the loading ring portion 32. The rotary disc 4 is provided with an inner circular track 41 and an outer circular track 42, both arranged horizontally, an inner conductive ring 43 and an outer conductive ring 44 respectively mounted in the inner circular track 41 and the outer circular track 42, and a wire seat 45 disposed on a lower part of the rotary disc 4 and used for introducing a wire 46. A positive electrode and a negative electrode of the wire 46 are respectively electrically connected to the inner and the outer conductive rings 43, 44. In a preferred embodiment, the rotary disc 4 is produced by injection molding and the inner and the outer conductive rings 43, 44 are respectively formed in the inner and the outer circular tracks 41, 42 by insert molding.

The rotary disc cover 5 is covering the rotary disc 4 and connected to the base 3. The rotary disc cover 5 is composed of an inner groove 51 and an outer groove 52 both arranged horizontally and disposed on a bottom surface of the rotary disc cover 5, and at least two inner guide assemblies 53 and at least two outer guide assemblies 54 respectively arranged at the inner groove 51 and the outer groove 52. The inner groove 51 is provided with a plurality of inner through-hole posts 511 and each of the inner guide assemblies 53 consists of an inner conductive strip 531, an inner conductive pin 532 connected to the inner conductive strip 531 and having one end in contact with the inner conductive ring 43, and a first elastic member 533 fitted to the other end of the inner conductive pine 532. The first elastic member 533 is mounted into the inner through-hole post 511. The inner conductive strips 531 of the two inner guide assemblies 53 are fastened and connected with each other. The outer groove 52 is provided with a plurality of outer through-hole posts 521. Each of the outer guide assemblies 54 includes an outer conductive strip 541 and an outer conductive pin 542 connected to the outer conductive strip 541 and having one end in contact with the outer conductive ring 44, and a second elastic member 543 mounted to the other end of the outer conductive pin 542. The second elastic member 543 is mounted into the outer through-hole post 521. The outer conductive strips 541 of the two outer guide assemblies 54 are fastened and connected with each other.

The upper cap 6 is covering the rotary disc cover 5 and connected to the steering wheel 1. The upper cap 6 consists of an axial mounting hole 61 in which a detachable bushing 7 is mounted, a wire hole 62 disposed on one side of the axial mounting hole 61, and a transmission wire 63 inserted through the wire hole 62 and electrically connected to the steering wheel 1. The bushing 7 is provided with an axial hole 71 which the control shaft 2 is inserted through and connected with.

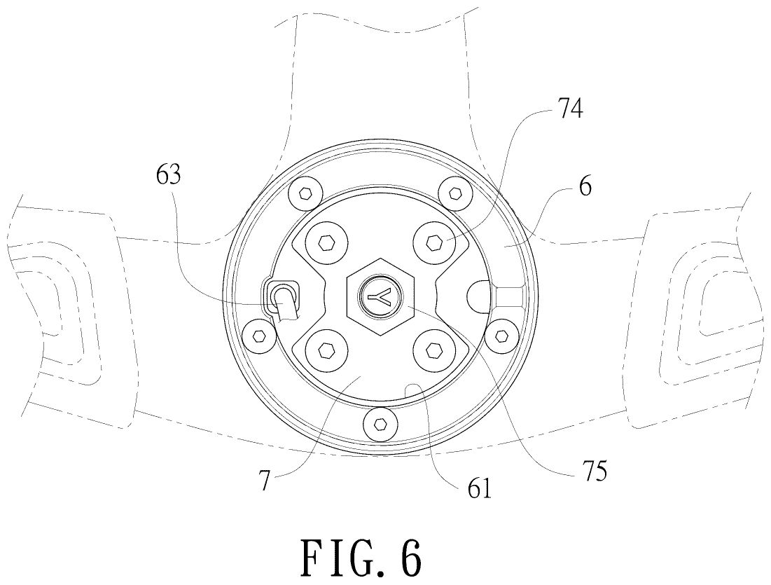

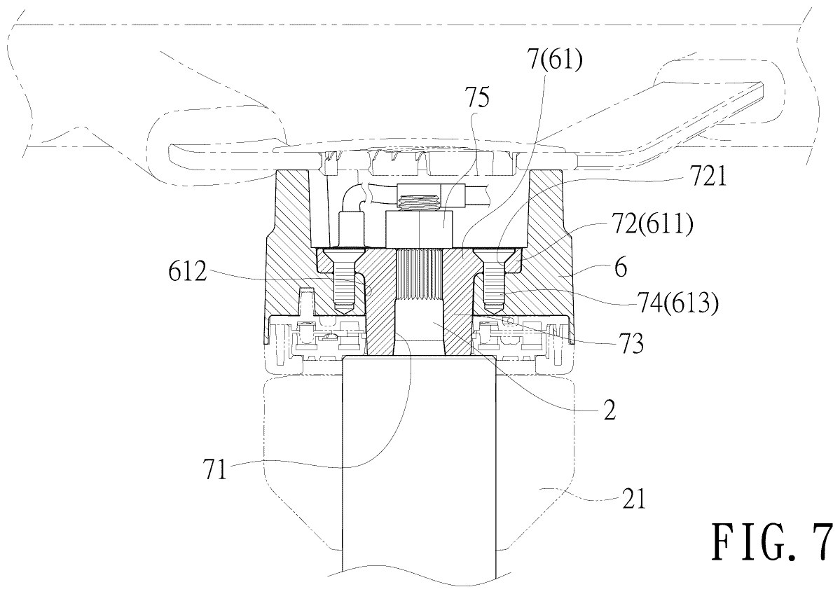

As shown in FIG. 6, FIG. 7, the bushing 7 is further provided with a stylish surface 72 disposed on an upper end of the bushing 7 and a shaft seat 73 integrally extended downward from the stylish surface 72. At least one fastening hole 721 is formed on the stylish surface 72 and the axial mounting hole 61 of the upper cap 6 is provided with a first hole 611 having the same style as the stylish surface 72 and corresponding to the stylish surface 72, a second hole 612 corresponding to the shaft seat 73, and a threaded hole 613 disposed on an end surface of the first hole 611 and corresponding to the fastening hole 721. By threaded members 74 inserted through the fastening holes 721 and the threaded holes 613, the bushing 7 is mounted and fixed in the upper cap 6.

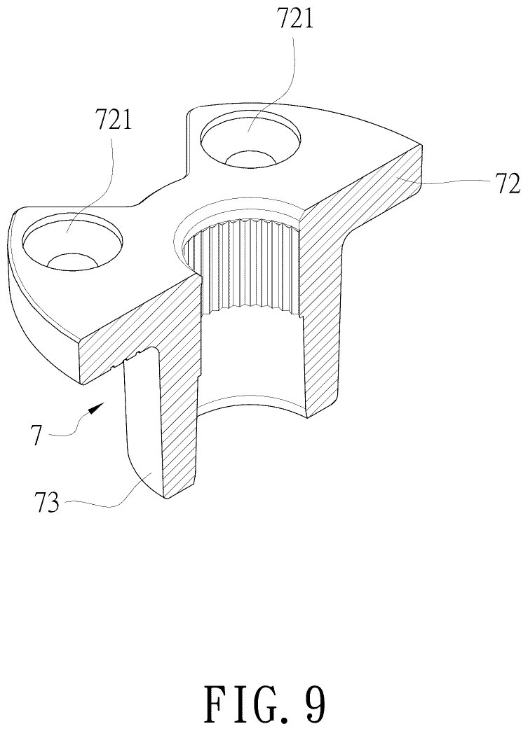

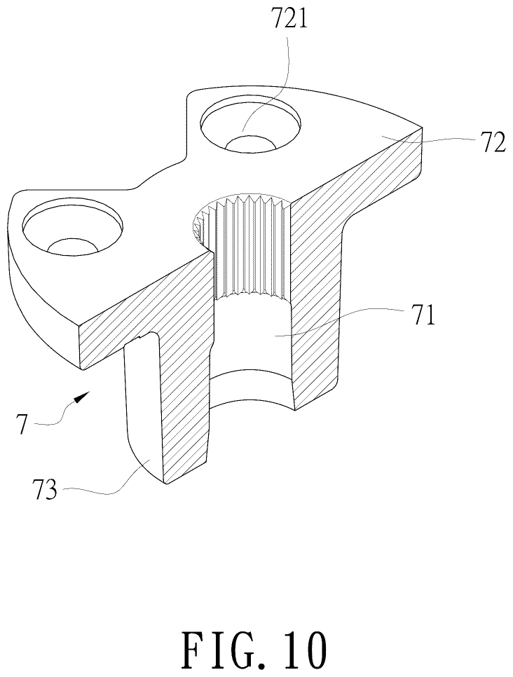

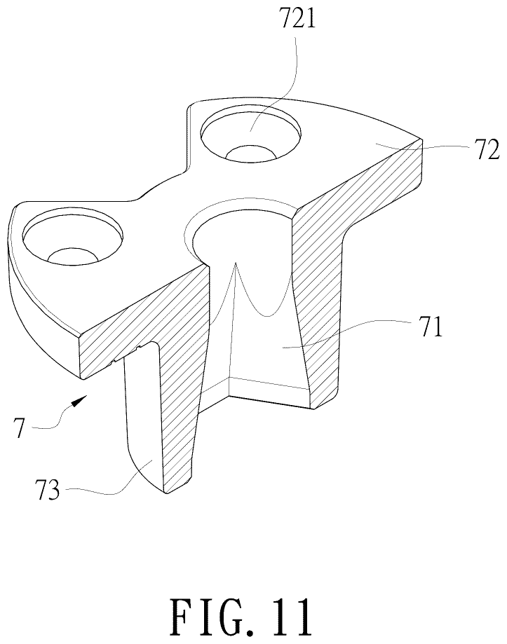

How the wheel base module A is assembled with the steering wheel 1 is described in detail in the below with reference to FIG. 1 to FIG. 12.

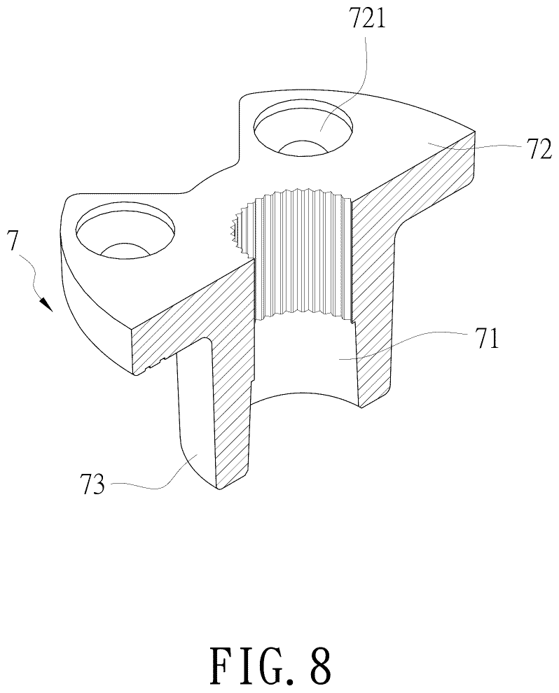

Before assembly, select the bushing 7 according to the control shaft 2 of the vehicle going to be assembled. As shown in FIG. 8-11, the respective bushings 7 have different styles of the axial holes 71 which are corresponding to the control shafts 2 of the different vehicles. According to the vehicles, the bushing 7 is mounted into the axial mounting hole 61 of the upper cap 6. By the design of the stylish surface 72 of the bushing 7 and the first hole 611 of the upper cap 6 mounted to and assembled with each other, good positioning and limit functions are provided and the bushing 7 is fixed by threaded members 74 inserted therethrough. Please refer to the above description and no further details are provided. The present heated steering wheel is different from conventional designs such as an upper cover with an integrally-formed axial hole or an assembly base with an axial hole formed in the upper cover by injection molding, which is unable to be replaced. The present heated steering wheel 1 can be mounted to different vehicles so that it's a universal part and the cost is reduced.

Refer to FIG. 1-5, the inner and the outer conductive rings 43, 44 are respectively mounted into the inner and the outer circular tracks 41, 42 of the rotary disc 4 and the positive electrode and the negative electrode of the wire 46 introduced by the wire seat 45 are respectively connected to the inner conductive rings 43 and the outer conductive ring 44. The above process is carried out by insert molding. Then the rotary disc 4 is mounted into the base 3 and located at the loading ring portion 32. As to the assembly of the rotary disc cover 5, firstly the at least two inner guide assemblies 53 are arranged at the inner groove 51. The first elastic member 533 is mounted into each of the inner through-hole posts 511 of the inner groove 51. Then the inner conductive pin 532 on the inner conductive strip 531 is abutting against the first elastic member 533. At the same time, inner conductive strip 531 is located in the inner groove 51 and one ends of the two inner conductive strips 531 of the two inner guide assemblies 53 are overlapped, fastened and connected with the inner groove 51 of the rotary disc cover 5. In order to prevent the first elastic member 533 from deforming during rotational displacement, a protruding cap 55 is disposed on one end of the inner through-hole post 511 and one end of the first elastic member 533 is corresponding to the protruding cap 55 while the inner conductive pin 532 is provided with an inner projecting member 5320 corresponding to the other end of the first elastic member 533. Thereby the first elastic member 533 is limited by protruding cap 55 and the inner projecting member 5320, without having dislocation and deformation.

Similarly, the at least two outer guide assemblies 54 are mounted to the outer groove 52 of the rotary disc cover 5 in the same way as the inner projecting member 53 being mounted in the inner groove 51. First the second elastic member 543 is mounted into each of the outer through-hole posts 521 of the outer groove 52. Then the outer conductive pin 542 on the outer conductive strip 541 is abutting against the second elastic member 543. At the same time, the outer conductive strip 541 is located in the outer groove 52 and one ends of the two outer conductive strips 541 of the two outer guide assemblies 54 are overlapped, fastened and connected with the outer groove 52 of the rotary disc cover 5. In order to prevent the second elastic member 543 from deforming during rotational displacement, a protruding cap 55 is disposed on one end of the outer through-hole post 521 and one end of the second elastic member 543 is corresponding to the protruding cap 55 while the outer conductive pin 542 is provided with an outer projecting member 5420 corresponding to the other end of the second elastic member 543. Thereby the second elastic member 543 is limited by the protruding cap 55 and the outer projecting member 5420, without having dislocation and deformation. Therefore, the steering wheel can be rotated and used repeatedly, without deformation after long-term use.

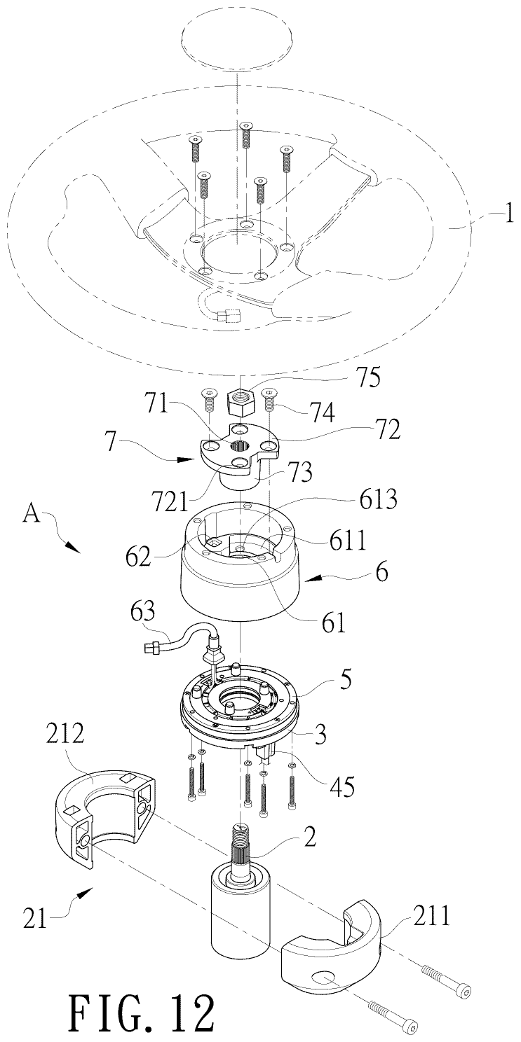

Also refer to FIG. 12, the rotary disc cover 5 is not only covering and located over the rotary disc 4 but also fastened and connected with the base 3. The inner conductive pins 532 in the inner guide assemblies 53 and the outer conductive pin 542 in the outer guide assemblies 54 of the rotary disc cover 5 are respectively in contact with the inner conductive ring 43 and the outer conductive ring 44 of the rotary disc 4. Then the upper cap 6 covers the rotary disc cover 5. The wheel base module A is aligned with the control shaft 2 and then the control shaft 2 is inserted through the hole 31 of the base 3, the rotary disc 4, and the rotary disc cover 5 to be mounted into the axial hole 71 of the detachable bushing 7 in the upper cap 6 and a nut 75 is aligned and threaded with the control shaft 2. Lastly, the upper cap 6 aligned and assembled with the steering wheel 1 and the transmission wire 63 is electrically connected to the steering wheel 1.

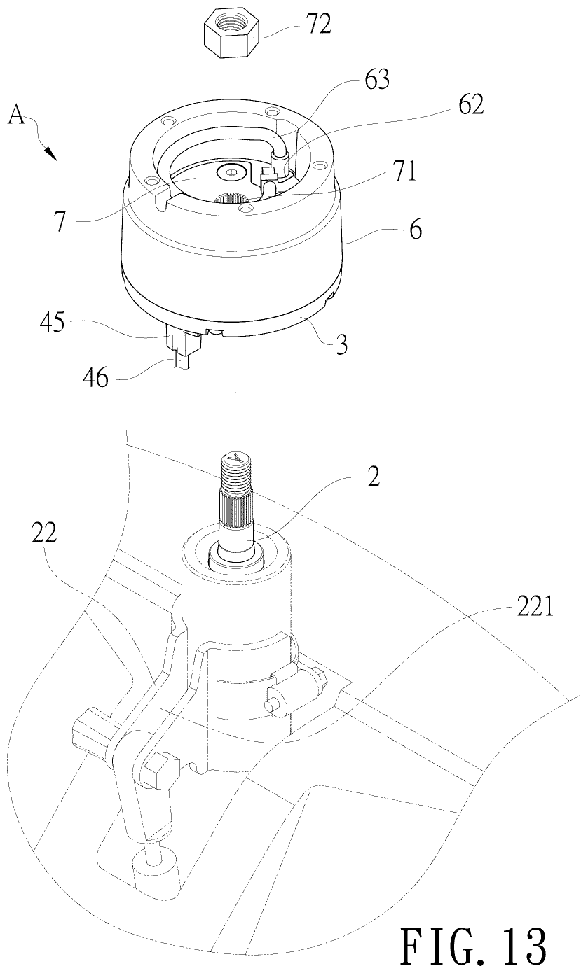

Moreover, it should be noted that when the wire seat 45 which is used for introducing the wire 46 and located on the lower part of the rotary disc 4 is positioned at the vehicle, the wire seat 45 can be mounted in a second limit slot 221 formed in a C-shaped fastener 22 fixed on the control shaft 2 correspondingly, as shown in FIG. 13. As shown in FIG. 1, a clamp ring set 21 is fit around the control shaft 2 and composed a first clamp ring 211 and a second clamp ring 212 which are respectively provided with a first recess 213 and a second recess 214 used for mounting the control shaft 2 therebetween. The first and the second clamp rings 211, 212 are fastened with each other and the first recess 213 is provided with a first limit slot 215 which is corresponding to the wire seat 45 and used for mounting and positioning the wire seat 45.

While rotating the steering wheel 1, the left turning or right turning of the steering wheel 1 also drives the upper cap 6 of the wheel base module A. Thus the bushing 7 is also driven to move the control shaft 2 for control of wheel sets of the vehicle. Now the clamp ring set 21 and the C-shaped fastener 22 outside the control shaft 2 won't rotate. The wire seat 45 is limited by the first limit slot 215 of the clamp ring set 21, or the second limit slot 221 of the C-shaped fastener 22 to brake the rotary disc 4. Thus the rotary disc 4 doesn't rotate. On the other hand, the steering wheel 1 moves the upper cap 6 to drive both the rotary disc cover 5 and the base 3 to rotate. When the rotary disc cover 5 is rotated, the inner and the outer guide assemblies 53, 54 of the rotary disc cover 5 keep good contact with the inner and the outer conductive rings 43, 44 of the rotary disc 4 to be in conducting state. By the inner and the outer conductive pins 532, 542 being pressed against by the inner and the first and the second elastic members 533, 543, the inner and the outer conductive pins 532, 542 keep good contact with the inner and the outer conductive rings 43, 44 of the rotary disc 4. Even the inner and the outer conductive pins 532, 542 have certain wear and tear, the good contact can still be maintained. Furthermore, since there are at least two inner guide assemblies 53 and at least two outer guide assemblies 54 disposed on the rotary disc cover 5, the conductive pins 532, 542 and the conductive rings 43, 44 are still in good conducting state even one set of the inner and the outer guide assemblies 53, 54 is out of order. Therefore, not only reliable electrical conduction is provided, the volume is compacted, and limits or tangling problems caused by use of flexible flat cables can be avoided, the same set of the heated steering wheel can be applied to different types of vehicles conveniently.

In summary, the present heated steering wheel has the following advantages.

1. By replacement of the bushings with different styles of the axial holes, the wheel base module can be mounted to different types of vehicles. Thus cost for molds and product stock is significantly reduced and the heated steering wheel with universal design can be widely used.

2. The positive and the negative electrodes are conducting by horizontal and radial contact between the inner and the outer conductive rings of the rotary disc arranged horizontally and the inner and the outer guide assemblies of the rotary disc cover arranged in the horizontal direction. Thus the whole volume is effectively reduced. Moreover, a thickness of copper plates of the conductive rings is much larger than that of conductive copper foil of the flexible flat cables available now so that the above design is more suitable for high-current and high-power applications. Not only heating speed is increased, abrasive resistance and service life of electrical conductors are also improved.

3. By the elastic members pressing against the conductive pins, the conductive pines keep good contact with the conductive rings. Even the conductive pins have certain wear and tear, the good contact still can be maintained.

4. Owing to at least two inner guide assemblies and at least two outer guide assemblies disposed on the rotary disc cover, the conductive pins and the conductive rings are still in good conducting state even one set of the inner and the outer guide assemblies is out of order.

5. The rear end of the conductive pin in the guide assembly is provided with the projecting member fitted with the elastic member correspondingly for limiting the elastic member so that the elastic member is positioned well, without dislocation and deformation.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A heated steering wheel able to be mounted to different types of vehicles conveniently comprising a wheel base module disposed under a steering wheel and connected to a clamp ring set which connects to and drives a control shaft for steering of vehicles; wherein the wheel base module includes:
a base provided with a hole disposed on a center of the base and a loading ring portion mounted to an inner circumference of the hole;
a rotary disc mounted into the base correspondingly and loaded on the loading ring portion; the rotary disc is provided with an inner circular track disposed horizontally, an outer circular track arranged horizontally, an inner conductive ring mounted in the inner circular track, an outer conductive ring mounted in the outer circular track, and a wire seat disposed on a lower part of the rotary disc and used or introducing a wire having a positive electrode and a negative electrode respectively electrically connected to the inner conductive ring and the outer conductive ring;
a rotary disc cover covering the rotary disc and connected to the base; the rotary disc cover having an inner groove disposed horizontally on a bottom surface of the rotary disc cover, an outer groove arranged horizontally on the bottom surface of the rotary disc cover, at least two inner guide assemblies mounted in the inner groove, and at least two outer guide assemblies arranged at the outer groove; the inner groove and the outer groove respectively provided with a plurality of inner through-hole posts and outer through-hole posts; each of the inner guide assemblies including an inner conductive strip and an inner conductive pin connected to the inner conductive strip; one end of the inner conductive pin in contact with the inner conductive ring and the inner conductive strips of the two inner guide assemblies fastened and connected with each other; each of the outer guide assemblies including an outer conductive strip and an outer conductive pin connected to the outer conductive strip; one end of the outer conductive pin in contact with the outer conductive ring and the outer conductive strips of the two outer guide assemblies fastened and connected with each other; and
an upper cap covering the rotary disc cover, connected to the steering wheel, and composed of an axial mounting hole in which a detachable bushing is mounted, a wire hole disposed on one side of the axial mounting hole, and a transmission wire inserted through the wire hole and connected to the steering wheel; the bushing provided with an axial hole which the control shaft is inserted through and connected with;
wherein the clamp ring set is composed a first clamp ring and a second clamp ring which are respectively provided with a first recess and a second recess used for mounting the control shaft therebetween; the first and the second clamp rings are fastened with each other and the first recess is provided with a first limit slot which is corresponding to the wire seat and used for mounting and positioning the wire seat.

2. The heated steering wheel as claimed in claim 1, wherein the bushing is further provided with a stylish surface disposed on an upper end of the bushing and a shaft seat integrally extended downward from the stylish surface; the axial hole is penetrating the stylish surface and the shaft seat; at least one fastening hole is formed on the stylish surface and the axial mounting hole of the upper cap is provided with a first hole having the same style as the stylish surface and corresponding to the stylish surface, a second hole corresponding to the shaft seat, and a threaded hole disposed on an end surface of the first hole and corresponding to the fastening hole; a threaded member is inserted through the fastening hole and fastened in the threaded hole for positioning.

3. The heated steering wheel as claimed in claim 1, wherein the other end of the inner conductive pin is provided with a first elastic member which is mounted into the inner through-hole post and the other end of the outer conductive pin is provided with a second elastic member which is mounted into the outer through-hole post.

4. The heated steering wheel as claimed in claim 3, wherein a protruding cap is disposed on one end of the inner through-hole post and one end of the first elastic member is corresponding to the protruding cap; the inner conductive pin is provided with an inner projecting member corresponding to the other end of the first elastic member; the first elastic member is limited by the protruding cap and the inner projecting member.

5. The heated steering wheel as claimed in claim 3, wherein a protruding cap is disposed on one end of the outer through-hole post and one end of the second elastic member is corresponding to the protruding cap; the outer conductive pin is provided with an outer projecting member corresponding to the other end of the second elastic member; the second elastic member is limited by the protruding cap and the outer projecting member.

6. The heated steering wheel as claimed in claim 1, wherein the inner conductive ring and the outer conductive ring are respectively mounted in the inner circular track and the outer circular track by insert molding.

7. A heated steering wheel able to be mounted to different types of vehicles conveniently comprising a wheel base module disposed under a steering wheel and connected to a C-shaped fastener which connects to and drives a control shaft for steering of vehicles; wherein the wheel base module includes:
a base provided with a hole disposed on a center of the base and a loading ring portion mounted to an inner circumference of the hole;
a rotary disc mounted into the base correspondingly and loaded on the loading ring portion; the rotary disc is provided with an inner circular track disposed horizontally, an outer circular track arranged horizontally, an inner conductive ring mounted in the inner circular track, an outer conductive ring mounted in the outer circular track, and a wire seat disposed on a lower part of the rotary disc and used or introducing a wire having a positive electrode and a negative electrode respectively electrically connected to the inner conductive ring and the outer conductive ring;
a rotary disc cover covering the rotary disc and connected to the base; the rotary disc cover having an inner groove disposed horizontally on a bottom surface of the rotary disc cover, an outer groove arranged horizontally on the bottom surface of the rotary disc cover, at least two inner guide assemblies mounted in the inner groove, and at least two outer guide assemblies arranged at the outer groove; the inner groove and the outer groove respectively provided with a plurality of inner through-hole posts and outer through-hole posts; each of the inner guide assemblies including an inner conductive strip and an inner conductive pin connected to the inner conductive strip; one end of the inner conductive pin in contact with the inner conductive ring and the inner conductive strips of the two inner guide assemblies fastened and connected with each other; each of the outer guide assemblies including an outer conductive strip and an outer conductive pin connected to the outer conductive strip; one end of the outer conductive pin in contact with the outer conductive ring and the outer conductive strips of the two outer guide assemblies fastened and connected with each other; and
an upper cap covering the rotary disc cover, connected to the steering wheel, and composed of an axial mounting hole in which a detachable bushing is mounted, a wire hole disposed on one side of the axial mounting hole, and a transmission wire inserted through the wire hole and connected to the steering wheel; the bushing provided with an axial hole which the control shaft is inserted through and connected with;
wherein the C-shaped fastener is fixed on and located outside the control shaft and provided with a second limit slot used for mounting and positioning the wire seat.

8. The heated steering wheel as claimed in claim 7, wherein the bushing is further provided with a stylish surface disposed on an upper end of the bushing and a shaft seat integrally extended downward from the stylish surface; the axial hole is penetrating the stylish surface and the shaft seat; at least one fastening hole is formed on the stylish surface and the axial mounting hole of the upper cap is provided with a first hole having the same style as the stylish surface and corresponding to the stylish surface, a second hole corresponding to the shaft seat, and a threaded hole disposed on an end surface of the first hole and corresponding to the fastening hole; a threaded member is inserted through the fastening hole and fastened in the threaded hole for positioning.

9. The heated steering wheel as claimed in claim 7, wherein the other end of the inner conductive pin is provided with a first elastic member which is mounted into the inner through-hole post and the other end of the outer conductive pin is provided with a second elastic member which is mounted into the outer through-hole post.

10. The heated steering wheel as claimed in claim 8, wherein a protruding cap is disposed on one end of the inner through-hole post and one end of the first elastic member is corresponding to the protruding cap; the inner conductive pin is provided with an inner projecting member corresponding to the other end of the first elastic member; the first elastic member is limited by the protruding cap and the inner projecting member.

11. The heated steering wheel as claimed in claim 8, wherein a protruding cap is disposed on one end of the outer through-hole post and one end of the second elastic member is corresponding to the protruding cap; the outer conductive pin is provided with an outer projecting member corresponding to the other end of the second elastic member; the second elastic member is limited by the protruding cap and the outer projecting member.

12. The heated steering wheel as claimed in claim 7, wherein the inner conductive ring and the outer conductive ring of the rotary disc are respectively mounted in the inner circular track and the outer circular track by insert molding.
